(19) United States
(12) Patent Application Publication
(10) Pub. No.: US 2020/0387498 A1
(43) Pub. Date: Dec. 10, 2020

(54) METHODS AND SYSTEMS FOR MULTI-VERSION UPDATING OF DATA STORED IN A DATA STORAGE SYSTEM

(71) Applicant: TELEFONAKTIEBOLAGET LM ERICSSON (PUBL), Stockholm (SE)

(72) Inventors: Anders SUNDELIN, KARLSKRONA (SE); Jim HÅKANSSON, Karlskrona (SE); Mattias NILSSON, Rödeby (SE)

(21) Appl. No.: 16/607,166

(22) PCT Filed: Apr. 24, 2017
(86) PCT No.: PCT/SE2017/050401

§ 371 Date: Oct. 22, 2019

(51) Int. Cl. G06F 16/23; G06F 16/21

(52) U.S. Cl. CPC G06F 16/2365; G06F 16/213; G06F 16/219; G06F 16/2358

(57) ABSTRACT

There is described a method and system for multi-version updating of data records in a data processing system. The method includes: receiving a message indicating that a first data record with a specified key has been stored or updated using a first schema; retrieving the first data record from a first location using the specified key; converting, by a transformation function, the first data record into a second data record using a second schema, wherein the first schema and the second schema are different; and transmitting the second data record for storage in a second location.

### TECHNICAL FIELD

The present invention generally relates to a data processing systems and methods and, more particularly, to such systems and methods which are configured to serve multiple versions of clients at the same time.

### BACKGROUND

A typical database application can consist of three different layers or components, i.e., a client, a server and a persistent data storage, where the client and the server are typically two processes or applications operating on two separate hardware platforms. The persistent data storage includes files or records stored in a file system often close to the server process. The client typically requests changes to data in a database and the server is responsible for encoding/decoding and serialization of the data structure to the persistent storage. Both the client and the server are aware of the data model used by the database, by, for example, a definition or schema decided by the client. When the client requests a read/write operation of some data in the database, the communication is done in such a way that the client requests particular parameters, defined in the schema, from the server. The server uses the schema to know where the serialized data with the requested parameters are stored.

An example of how data can be represented in the different layers and how the data can be transformed between the layers using conventional methods is shown in FIG. 1. FIG. 1 depicts an application 100, which runs on a client 102, which is also known as a database (DB) client, a DB server 104 and a persistent storage 106, e.g., a memory. The application 100 has an internal structure of its data, for example, as a Java object in a Java application. The application 100 then transforms the data of the object to arguments in a Structured Query Language (SQL) statement when sending the data to the database server 104. The DB server 104 receives the request and updates its internal structure while also transforming the data to the persistent storage if the data differs from its previous internal format.

An example of this can be seen in FIG. 1, where the client 102 executing the application 100 creates a table named “Car” which is formed with an id string, a weight integer (int), a color string and a price int field. Values can then be inserted into the table Car 108, e.g., ABC 123, 1000, blue, 3000. The table Car 108 can be seen in the DB server 104. At some point in time, the client 102 executing the application 100 can decide to perform a read/write operation to table Car 108, e.g., read id, weight, color and price from Car 108 where the id is “ABC 123”. The id can be used as a pointer to the location of the data table. After the read/write operation is complete, the DB server 104 can transform the data using a codec 110 into, for example, a binary format, for storage in the persistent storage 106.

In technologies involving server-side encoding, it is often the case that the same schema is used for all clients of a datatype, for example, a table in a relational SQL database. If a small change to the schema, e.g., a new parameter or column, is needed one client adds it and the parameter or column is immediately visible for all of the other clients using the same datatype. For large restructurings or reorganizing of data, data migration is typically required. This data migration often involves application specific scripts, in a process called Extract-Transform-Load (ETL). In such cases, the old schema will be completely replaced by the new schema and clients expecting data to be organized according to the old schema can have problems operating correctly, as the old schema will no longer be compatible with the new schema. This forces software updates of such client applications, which can be expensive in terms of cost and time.

An alternative to using the server-side encoding shown in FIG. 1, is to use client-side encoding with a central schema storage as shown in FIG. 2. In this example, the clients 200 and 202 are responsible for encoding and decoding a record according to a defined schema, which schema is stored in the central schema storage 204, with their associated codec 212 and 216, respectively. Each client 200 and 202 also serves an application 210 and 214, respectively. The DB server 206 stores and retrieves the encoded record including a Binary Large OBject (BLOB) value associated with each key. The BLOB portion of the encoded record is also stored in a persistent storage 208 in a binary format which is the same format as found at the client 200 and/or 202.

An example of this can be seen in FIG. 2, where the client 200 and/or 202 executing the application 210 and/or 214 inserts information, e.g., id, name, version and definition, into the central schema storage 204 as can be seen in table 218. A data record is then encoded by the codec 212 and/or 216 using the desired schema. The encoded record includes a data field in a binary format. This encoded record is then inserted in the DB server 206 as seen in table Car 220, e.g., ABC 123, 0x12345, 123. The id can be used as a pointer to the location of the record in the table 220 for future use by the applications 210 and 214. The binary data portion of the encoded record is then stored in the same format as it was encoded in the client 200 and/or 202 as can be seen by the binary data shown in table 220 and in the persistent storage 208, e.g., 0x12345, 0x3569, 0x2468.

The above described current server-side and client-side encoding methods have limitations in some situations, for example, how to handle clients using different client software versions. When different software versions are in use at the same time, some clients might assume that the encoded records are in a format according to a first schema and while other clients might assume, for example due to additional functionality, that the encoded records are formatted according to a second schema. In the case described with respect to FIG. 1 for server-side encoding, this problem can be solved by forcing all clients to adapt to the newest schema. This may be acceptable in some cases when the changes between schemas are small, but is not sufficient in the more typical case of many changes. Clients expecting the data to be in the format of the old schema could stop working unless the two schemas are sufficiently compatible, e.g., an attribute added or removed and replaced with a default value.

In the case described with respect to FIG. 2 for client-side encoding, this problem is solved in some cases by relying upon the characteristics of most schema languages in which there is some allowance for extensibility. For example, adding a field with a default value, renaming a field and some limited type conversions, e.g., changing an integer to a long or a double precision value may be changes to which clients can adapt. However, when major restructuring of the data is needed, for example, when splitting one entry into different entities, relying only on the schema languages' capabilities is no longer sufficient.

Thus, there is a need to provide methods and systems that overcome the above-described drawbacks associated with using multiple schemas/client versions at a same time in a data processing system.

### SUMMARY

Embodiments allow for a central schema storage to be augmented to also include parameters associated with the transformation of data, e.g., database records, allowing multiple versions of encoded records to simultaneously exist in different locations within a same memory storage device. This allows clients of different versions to operate at the same time, while still keeping the encoded records consistent and available on all desired nodes at all times.

According to an embodiment, there is a method for multi-version updating of data in a data processing system. The method includes: receiving a message indicating that a first data record with a specified key has been stored or updated using a first schema; retrieving the first data record from a first location using the specified key; converting, by a transformation function, the first data record into a second data record using a second schema, wherein the first schema and the second schema are different; and transmitting the second data record for storage in a second location.

According to an embodiment, there is a data processing system for multi-version updating of data. The system includes: a first client device which receives a message indicating that a first data record with a specified key has been stored or updated using a first schema; wherein the first client device retrieves the first data record from a first location using the specified key; a transformation function processor, associated with the first client device, which converts the first data record into a second data record using a second schema, wherein the first schema and the second schema are different; and wherein the first client device transmits the second data record for storage in a second location.

According to an embodiment, there is a computer-readable storage medium containing a computer-readable code that when read by a computer causes the computer to perform a method of for multi-version updating of data in a data processing system. The method includes: receiving a message indicating that a first data record with a specified key has been stored or updated using a first schema; retrieving the first data record from a first location using the specified key; converting, by a transformation function, the first data record into a second data record using a second schema, wherein the first schema and the second schema are different; and transmitting the second data record for storage in a second location.

According to an embodiment, there is an apparatus adapted to receive a message indicating that a first data record with a specified key has been stored or updated using a first schema, to retrieve the first data record from a first location using the specified key, to convert, by a transformation function, the first data record into a second data record using a second schema, wherein the first schema and the second schema are different, and to transmit the second data record for storage in a second location.

According to an embodiment, there is an apparatus including: a first module configured to receive a message indicating that a first data record with a specified key has been stored or updated using a first schema; a second module configured to retrieve the first data record from a first location using the specified key; a third module configured to convert, by a transformation function, the first data record into a second data record using a second schema, wherein the first schema and the second schema are different; and a fourth module configured to transmit the second data record for storage in a second location.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows server-side encoding for a data processing system;

FIG. 2 illustrates client-side encoding for a data processing system;

FIG. 3 shows a transformation function according to an embodiment;

FIGS. 4 through 8 illustrate storing data with two different schema versions according to an embodiment;

FIG. 9 shows transformation of data according to an embodiment;

FIG. 10 shows a flowchart of a method for migration of data according to an embodiment;

FIGS. 11A and 11B illustrate steps and signaling for migration of data according to an embodiment;

FIGS. 12A and 12B show steps and signaling for a reverse migration of data according to an embodiment;

FIG. 13 illustrates a cloud architecture according to an embodiment;

FIG. 14 shows a method for multi-version updating of data in a data processing system according to an embodiment;

FIG. 15 depicts a node for use in a data processing system according to an embodiment; and

FIG. 16 illustrates a carrier on which a computer program product according to an embodiment resides.

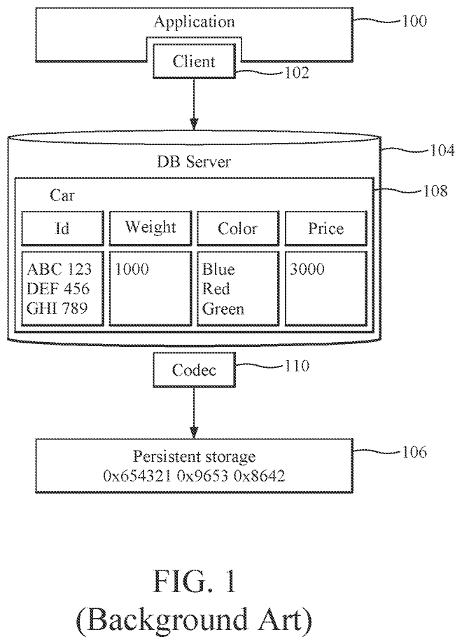

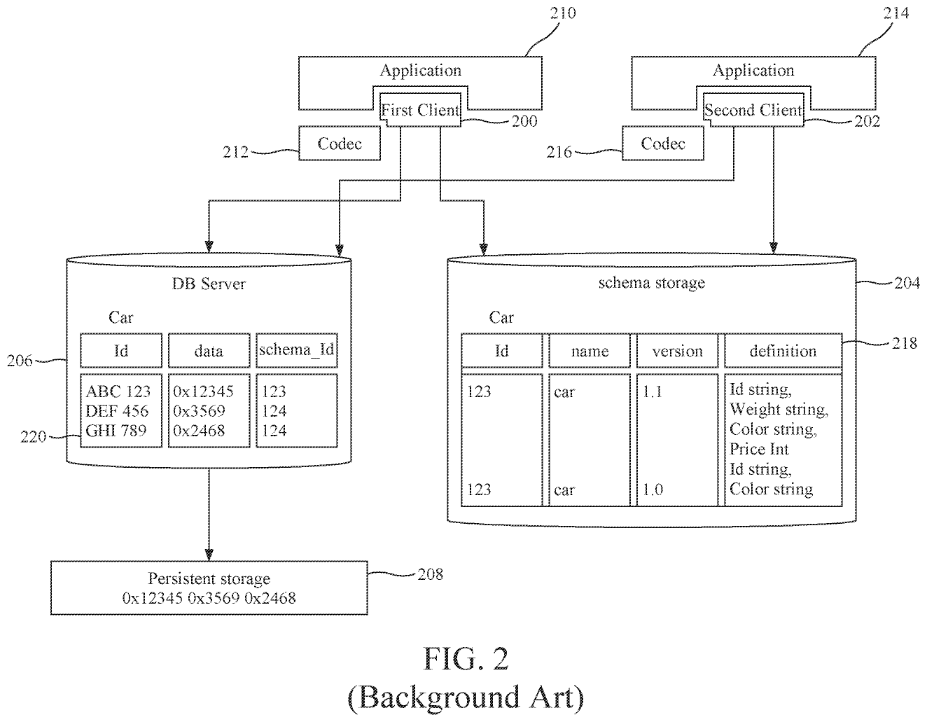

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The embodiments to be discussed next are not limited to the configurations described below, but may be extended to other arrangements as discussed later.

Reference throughout the specification to “one embodiment” or “an embodiment” means that a particular feature, structure or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

As described in the Background, there are drawbacks associated with using multiple schema versions and/or multiple client versions at a same time in a data processing system. Embodiments allow for clients of multiple versions to simultaneously exist, accessing the same database, where different versions of the data using different schemas, possibly in different locations of a same memory device, would reside. This capability can allow for seamless upgrades of data, without decreased availability or data loss and is generally referred to herein as “multi-version updating”.

Embodiments relate to the framework around application specific transformers, ensuring that data is consistently updated and that clients process the currently active version of the data. This enables the transformer to focus on actual transformation of data, e.g., transform data in a first schema to data in a second schema or vice-versa. The framework coordinates and synchronizes schema usage, e.g., when all first schema data is migrated it can be desirable to use data in the second schema and to start removing data encoded with the first schema from memory. Herein, a “schema” is understood to be the underlying organizational pattern or structure used for representing a data record or object. For example, a schema associated with a given type of record defines the fields included in the record, the order of the fields, the field type(s) and formats.

Embodiments also allow for the opposite approach known as a so-called “backwards” or reverse-migration of data, e.g., records stored in the new, second schema are transformed into an older, first schema, so that the records can be accessed by older clients in the format that the older clients expect and can use. Using this approach, as long as the transformer has not been disabled, it is expected that all second schema encoded records will be transformed into first schema encoded records. For these embodiments, it is expected that first schema and second schema encoded records will co-exist for a longer period of time than is the case for embodiments associated with forward migration. For clarity, as described herein, the first client may use a newer version of the client software than the second client but, more generally, the first client is simply different from the second client.

Embodiments augment a database (DB) client and associated schema storage with the functionality and data to be able to serve multiple versions of clients at a same time, while still processing read/write requests. The application specific transformation can be performed by the application itself, which operates on a client that can be a server. Alternatively, the data transformation can be performed by an entity which is independent of the application (but which is in communication therewith). The framework and structure of the data are handled by the DB and the DB client. Prior to describing these embodiments in more detail, some underlying contextual features are first described that support the various embodiments.

According to an embodiment, data records in the data processing system can be stored in a so-called “distributed Key/Value-store” encoded with a schema, e.g., schema S1. Each record stores, apart from its key and value, the schema id, e.g., 123 for schema S1. The schema storage, which can be a DB or another node, can be shared and accessible from all clients. As discussed above, an idempotent transformer operation is provided for transforming the records, using key set {K1}, e.g., {ABC 123}, encoded with a schema {S1}, e.g., {123}, into records using a second key set {K2}, e.g., {ABC 123, ABC 123-2017}, encoded with a second schema {S2}, e.g., 124, 125}. In a general case, schemas S1 and S2 could be sets of schemas, indicating multiple values mapping to multiple other values. Idempotency describes an operation that produces the same result when executed one or more times and can be a useful property for some embodiments, e.g., when a transformation needs to be able to be re-applied. For example, this can occur in the case when there has been a value update to a data record while the original transformation was being performed.

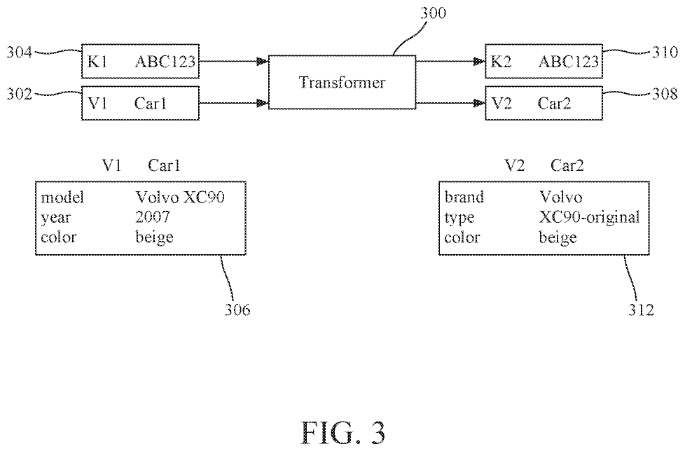

Thus, in order for embodiments to facilitate handling multiple versions of the encoded records an idempotent transformer operation for transforming data is provided and may be associated with one or more clients. An example of this transformation is now described with respect to FIG. 3. In this example, the value Car1 302 (which is encoded with schema S1 and stored with a key K1 304) is transformed by the transformer 300. Car1 302 is shown in box 306 and includes information associated with model, year and color. An example of this transformation function could be described by transform [K1,V1] map “model and year” to “brand and type”. The output of the transformation is shown by the value Car2 308 and stored with key K2 310, with the data of Car2 being shown in box 312 and including information associated with brand, type and color. Also, in this example, the values for the keys K1 304 and K2 310 are the same, however these key values can also be different.

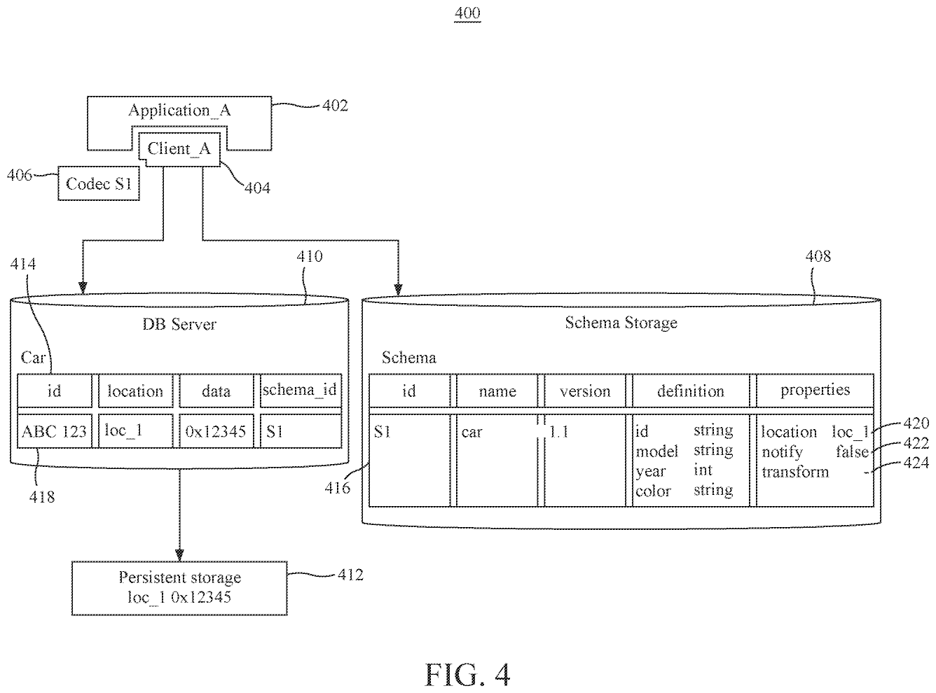

Using the above-described elements, a data processing system can be designed according to an embodiment which allows a first client to store data, e.g., as encoded records with one or more fields, according to two different schemas, in order to remain compatible with a second client or third client which has not yet been updated to a compatible software level. An example of such a data processing system will be described according to FIGS. 4 through 8 which show the data processing system at different points in time as clients, schemas and records are added or modified. Additionally, while only three clients and two schemas are shown for simplicity, it is to be understood that more clients and schemas can be used.

FIG. 4 shows a system 400, e.g., a data processing system, which includes a client_A 404 operating an application_A 402 and a codec 406, wherein the client is a database client. Additionally system 400 includes a schema storage 408, a DB server 410 and a persistent storage 412. For this example, at this point in time, the application_A 402 creates schema S1 using the codec 406, which is shown in schema storage 408 under the “id” S1 and includes schema information relating to name, version definitions and properties as shown in row 416.

According to an embodiment, one or more of three schema parameters or properties can be provided with various values: a location parameter 420, a notify parameter 422 and/or a transformation parameter 424. The location parameter 420 can indicate that data records encoded using a first schema S1 are stored in a first location and that data records encoded using a second schema are stored in a second location. This can be continued for the case where more than two schemas are used. The notify parameter 422 can indicate whether updating a data record encoded by the respective schema triggers generation of a message informing an element of the data processing system that something has changed. The transform parameter 424 can indicate the transformation function to be used to transform a data record encoded with the respective schema. These properties of schema S1 can be set, either by configuration, or by default values.

Application_A 402 then encodes a record with its codec 406 using the created schema S1 into an encoded record which includes a plurality of fields, e.g., id, location data and schema_id. This encoded record is shown by the stored row 412 of data in table Car 414 in the DB server 410. The DB server 410 then stores the BLOB portion of the encoded record and the location of the encoded record in the persistent storage 412.

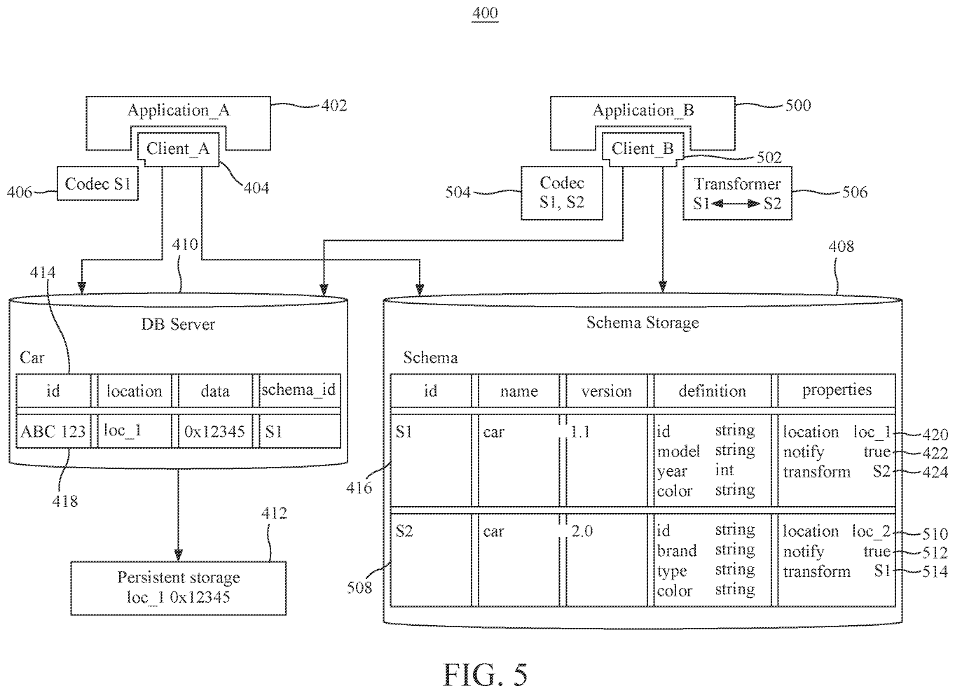

FIG. 5 shows the system 400 at another point in time to now additionally include client_B 502, operating a new application 500, another codec 504 and a transformer 506, wherein both clients are database clients. In this example, client_A 404 is considered to be the second client and client_B 502 is considered to be the first client with the first client being able to operate using a different schema than the second client. Client_B 502 can encode/decode records using either schema S1 or schema S2 as well as transform records between the two schemas. For this example, at this point in time, the application_B 500 creates schema S2 using the codec 504. The new schema S2, which is shown in schema storage 408 under the “id” S2 and includes information relating to name, version definitions and properties as shown in row 508. In particular, schema S2 includes a location parameter 510 for pointing to a location loc_2 (which is different than the location loc_1 which is pointed to by the location parameter 420 of schema S1), a notify parameter 512 having a value of “true”, and a transform parameter 514 indicating that S2 encoded data is to be transformed into S1 encoded data. Also, note that due to the addition of schema S2, certain parameters associated with schema S1 have had their values updated. In particular, for this embodiment, the notify parameter 422 has had its value changed from “false” to “true” and the transform parameter 424 has had its value changed from “nil” to “S2” such that data which is encoded using the S1 schema will thus forth be transformed also into S2 encoded data entries. These properties of schema S2 can be set, either by configuration, or by default values.

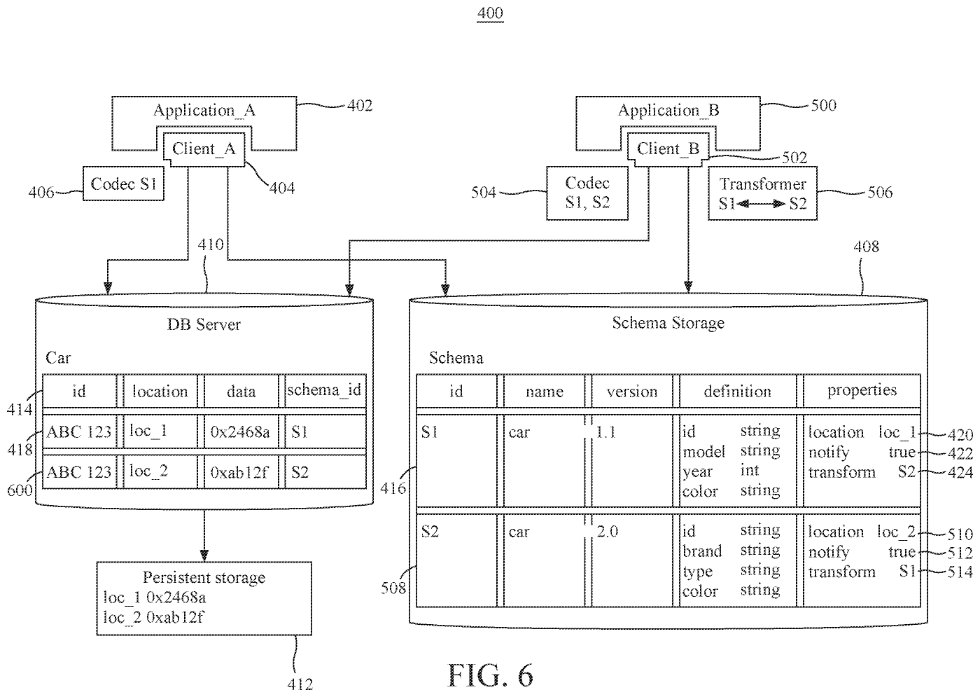

According to an embodiment, FIG. 6 shows the system of FIG. 5, at yet another point in time, storing a data record as shown in row 600 of table Car 414. This data record 600 could have been generated by transforming data record 410 using the transformer function 506 and then storing data record 600 in the DB server 410. Additionally, the blob associated with data record 600 is shown as being stored in the persistent storage 412 in loc_2 as indicated by location parameter 510.

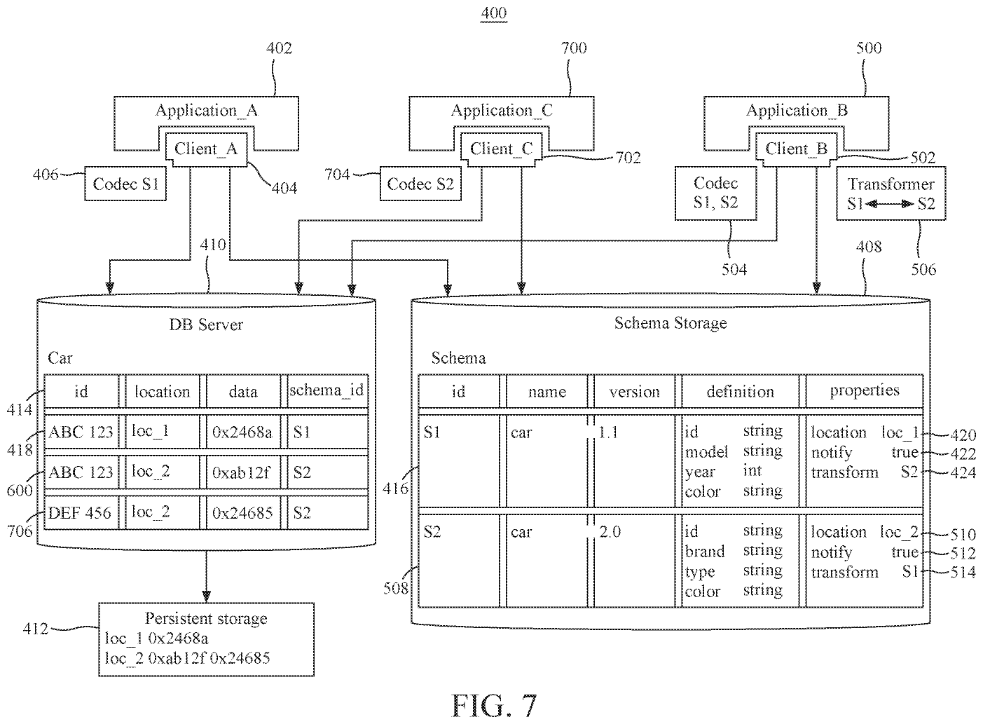

According to an embodiment, FIG. 7 shows the data processing system 400 at another point in time to now also include application_C 700 operating on client_C 702 which also includes a codec 704 which only uses schema S2. Also shown, is a new data record 706 which has been generated by client_C 704 as can be seen since the record was encoded using schema S2. Additionally, location 2 (loc_2) now has two blobs stored in it as seen in the persistent storage 412. Since the notify parameter 512 is set to “true”, other interested applications will also be notified about this new data.

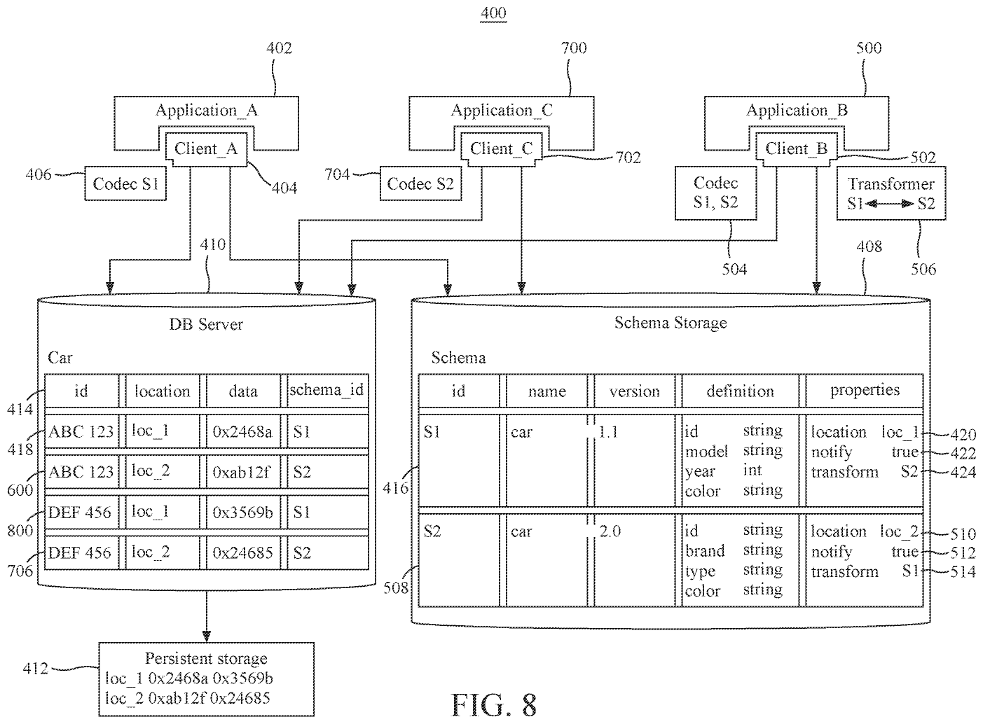

According to an embodiment, FIG. 8 shows another example of a transformation which occurs when Application_B 500 receives the notification associated with the addition of the new data in row 706 to the DB 410. In this example, encoded record 706 is then transformed using transformer 506 from the S2 schema into an encoded data record using the S1 schema and stored as row 800 in table Car 410 with the blob portion of the record stored in location 1 (loc_1) of the persistent storage 412.

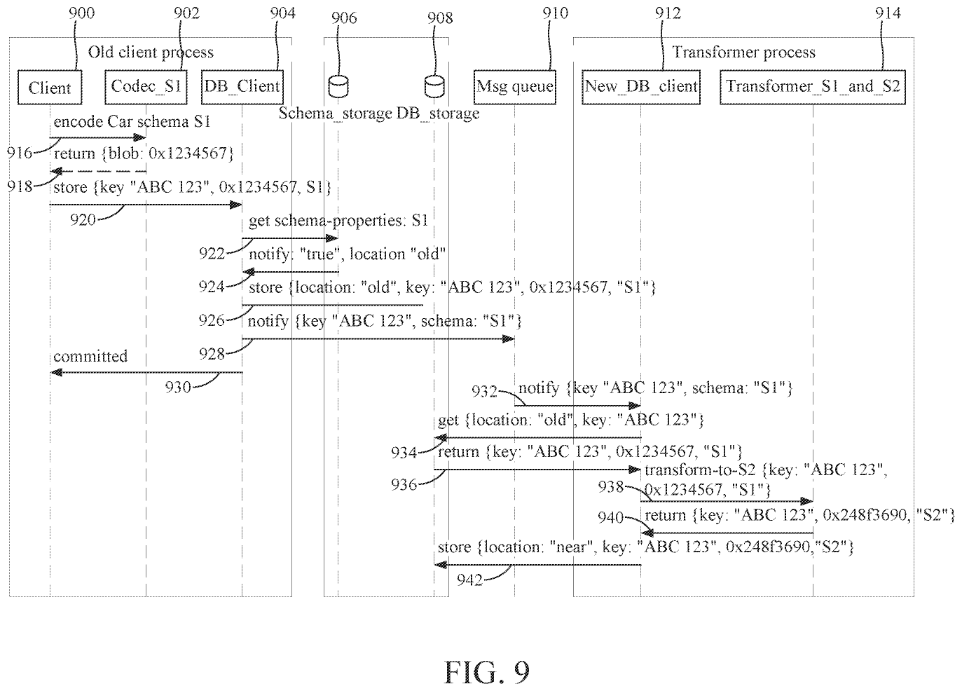

According to an embodiment, an example of migration where encoded records written with an old/second client, e.g., client_A 404, using the S1 schema are transformed into encoded records according to the S2 schema is now described with respect to FIG. 9. In this example, the client 900 and the DB client 904 are considered “old” or “second” as they are using an older or different schema S1 as compared to schema S2. Initially, the client 900 encodes a record, e.g., “Car”, using its old schema S1. This is shown by the encode Car step 916 from the client 900 to the Codec S1 902 and step 916 which shows the return blob step 918 from the Codec S1 902 to the client 900. The client 900 sends the key, schema and encoded blob to the DB client 904 in step 920. In step 922, the DB client 904 interacts with the schema storage DB 906 to check on the schema properties of S1 and determines, as shown in step 924, that the DB client 904 is to notify a message queue 910 on changes to entities with the schema S1. This can be done by, for example, using properties, flags, values or some combination thereof. In this example, S1 has a location of “old” which triggers the condition that the notify parameter has a value of true. Additionally, note that the DB client 904 does not need to know what has changed in the record, only that something has changed.

In step 926, the DB client 904 stores, in the DB storage 908 the newly encoded record with the specified key, in the old location as this is an “old” DB client 908 using the older schema S1. In step 928, the DB client 904 sends a notification to the message queue 910 stating that the record with the specified key has now changed. The DB client 904 informs the client 900 of this condition in step 930.

In step 932, the message queue 910 notifies the new DB client 912 which is in charge of the transformation process that there have been changes to specified keywords. Additionally, the new client DB 912 is capable of encoding records with both schemas S1 and S2. The new DB client 912 communicates with DB storage 908 to retrieve the record from the old location using the specified key as shown in steps 934 and 936. The new DB client 912 invokes the transformer 914 in order to convert the encoded record into a record encoded in the new schema S2, as shown in steps 938 and 940. The newly encoded blob is stored in the new location in DB storage 908 as shown in step 942. Additionally, according to an alternative embodiment, there can be cases where multiple keys and/or multiple schemas are used during the transformation process.

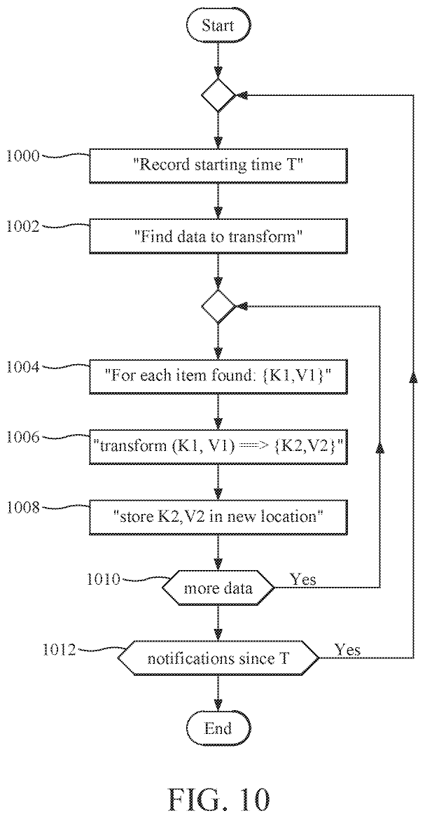

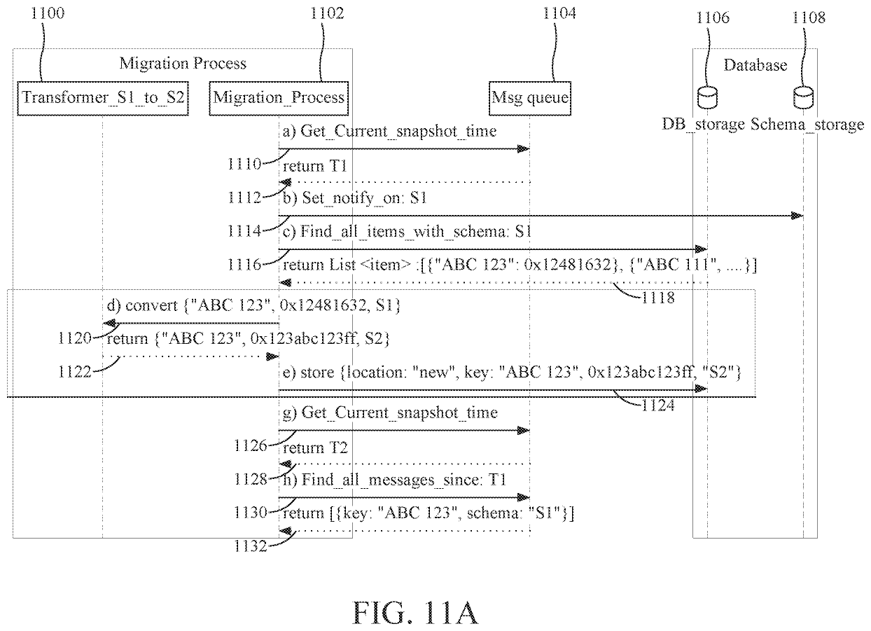

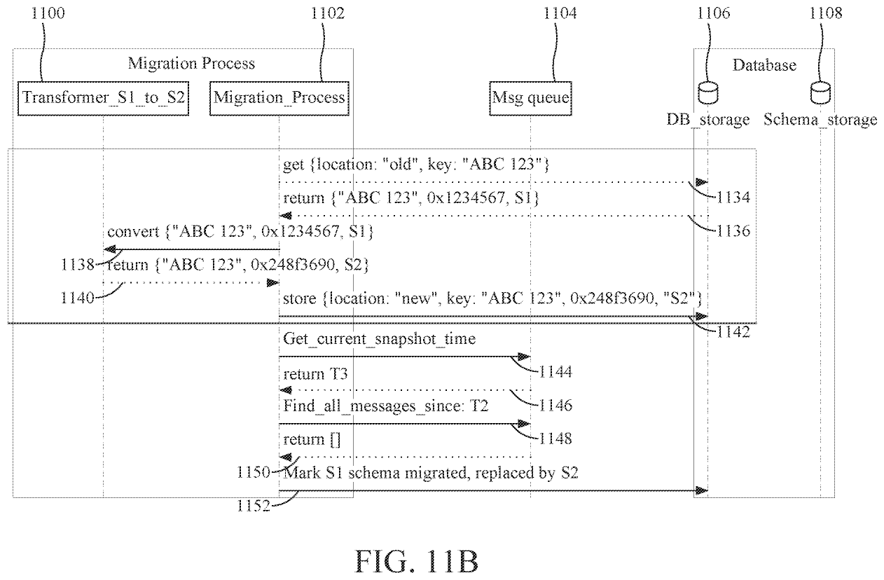

According to some embodiments, the storage of different versions of data encoded using different schemas can continue indefinitely. Alternatively, at some point in time, it may be desirable to remove one or more schema and the data encoded using that schema. Thus, according to an embodiment, the process of transforming all of the records encoded with S1 to a newer schema S2 is referred to as the migration process of S1 to S2. Once all clients in the data processing system which previously were only compatible with S1 have been upgraded to support S2 or decommissioned, the S1 encoded data can be removed as desired. FIGS. 10, 11A and 11B illustrate a method flow and a signaling diagram, respectively, for an embodiment of the migration process.

According to an embodiment, data records can be migrated from schema S1 to schema S2 as shown in the method flow diagram of FIG. 10. Initially, when starting the migration of encoded records from the S1 schema to the S2 schema, the system, in step 1000, records the starting time T. In step 1002, the system finds S1 encoded data to transform. In step 1004, for each item found, a combination of an associated key and value are formed. In step 1006, the transformation of the key and value from S1 to S2 occurs. In step 1008, the new key and value are stored in a new location. In step 1010, a determination is made as to whether or not more records have been found which need to be transformed at this point in time. If the determination is yes, then steps 1004, 1006, 1008 and 1010 are repeated. If the determination is no, then in step 1012 the system determines if there have been any more notifications received associated with storage of encoded records using S1 since time T. If the determination is yes, then one or more notifications have been received and steps 1000-1010 are repeated. If the determination is no, then the migration process is completed.

According to an embodiment, FIGS. 11A-11B shows steps associated with the migration process from a signaling diagram point of view from schema S1 to schema S2. In FIGS. 11A and 11B, the participating functions and/or nodes include the transformation function 1100, a migration process coordinator 1102 which can be a client server, a message queue 1104, a DB storage 1106 and a schema storage 1108. The DB storage 1106 and the schema storage 1108 can be a same DB or different DBs.

Initially, the migration process begins by recording the current logical timestamp T1. This is shown in FIG. 11A, by the get_current_snapshot_time message 1110 which is transmitted from the migration process coordinator 1102 to the message queue 1104. The message queue 1104 then returns T1 in message 1112 to the migration process coordinator 1102. The migration process persistently marks schema S1 as “notify:true” as shown in message 1114. The migration process then finds all records with schema S1 as shown in message 1116 from the migration process coordinator 1102 to the DB storage 1106. The DB storage 1106 then returns information regarding records encoded with schema S1 to the migration process coordinator 1102 as shown in message 1118.

For every record found, the system, through the use of the transformation process function 1100 (which may be a processor or some other processing component associated with the client server), transforms the record encoded with schema S1 into a record encoded with schema S2. This is shown in FIG. 11A by the convert message 1120 sent from the migration process coordinator 1102 to the transformer 1100 and by the return message 1122 from the transformer 1100 to the migration process coordinator 1102. The converted records will be stored in a new location (or address within the DB storage 1106), which is also indicated in the schema storage for the schema S2, as shown by message 1124 which is sent from the migration process coordinator 1102 to the DB storage 1106. The processes associated with messages 1120, 1122 and 1124 are iterated until no more records to be converted are found. Since the schema S1 is currently marked as “notify:true”, changes any client makes to any records encoded using schema S1 will cause a notification, via the message queue 1104, to be sent to the transformer process 1100, which then keeps track of which keys to re-scan and convert again.

According to an embodiment, when no more records were found to convert, the process can re-start, beginning with recording the current logical timestamp T2. This is shown in message 1126 which requests the current snapshot of time from the message queue 1104 and message 1128 which returns the timestamp T2 to the migration process coordinator 1102. This time the process only converts the records that have changed since logical timestamp T1, i.e., for those records whose keys where notifications have been received. Since schema S1 is still marked as “notify:true”, the schema storage does not need to be re-notified.

The migration process fetches all messages since T1 from the message queue. The messages include information about which key that was changed, and which schema was used for the value in that key, in the specified location as shown by message 1134 from the migration process 1102 to the DB storage 1106. For every message found, the record is retrieved from the specified location, e.g., “ABC 123” from “old” location as shown in message 836. The retrieved record, including the key and schemas S1 and S2 are sent to the corresponding application-specific transformer 1100 for the S1 schema, which converts the record into an encoded record using the S2 schema which happens when transformer 1100 receives the convert message 1138 from the migration process coordinator 1102. The transformed output is then returned to the migration process coordinator 1102 as shown in message 1140. The newly encoded record along with information from the schema storage is then transmitted from the migration process coordinator 1102 to the DB storage 1106 as shown in store message 1142 for storage in the “new” location using the key returned from the transformer process which, in some cases, is the same key as the input key. The steps associated with messages 1134, 1136, 1138, 1140 and 1142 are then repeated until there are no more messages to process.

At this point in time, the migration process restarts, as described above with respect to T2, by getting the current time logical timestamp T3 as shown in message 1144. The timestamp T3 is returned from the message queue 1104 to the migration process coordinator 1102 as shown in message 1146. The migration process coordinator 1102 then transmits a message 1148 to the DB storage 1106 to find all messages since T2. The DB storage 1106 then returns the results to the migration process coordinator 1102 as shown in return message 1150. In this case, no new records have been found using schema S1 since timestamp T2. Accordingly, the migration process can be considered to be complete.

Message 1152 in which the migration process coordinator 1102 instructs the schema storage 1108 to mark that schema S1 is migrated and replaced by schema S2, can be transmitted at a desirable future date and can be triggered by a configuration, e.g., human intervention, introduction of another, newer schema or a determination by the migration process that there is no more data to migrate. Additionally, once all of the clients requiring S1 encoded records are upgraded or decommissioned, these S1 encoded records could be discarded and the storage re-used for other purposes. According to an embodiment, for a distributed data storage service, the migration of the records is performed locally at each data host, using a coordinator node, which controls the updating of the schema properties. Additionally, according to an embodiment, a method of sending persistent messages between clients is provided and can be implemented, for example, as a message queue.

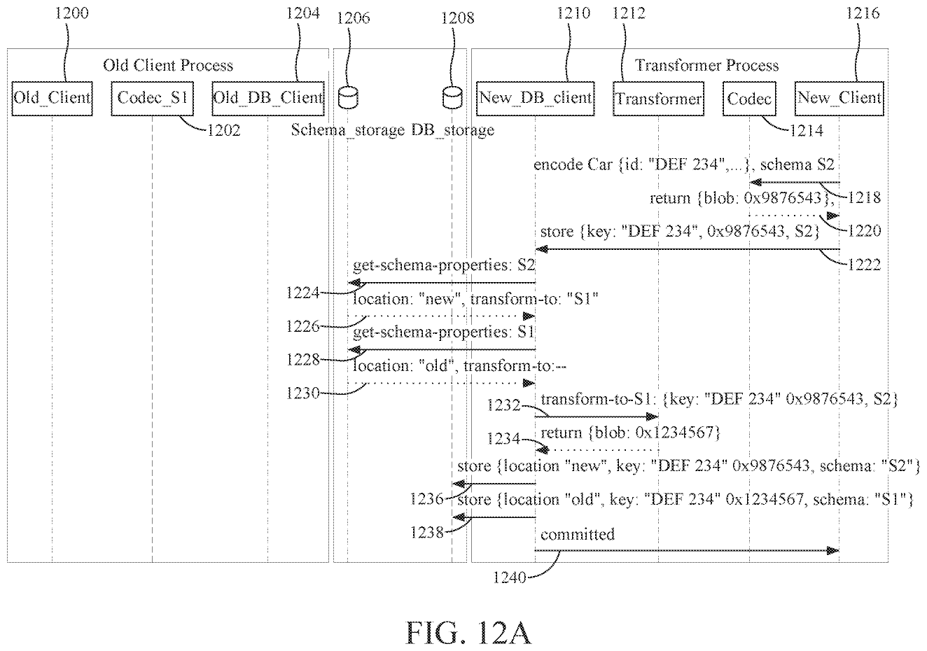

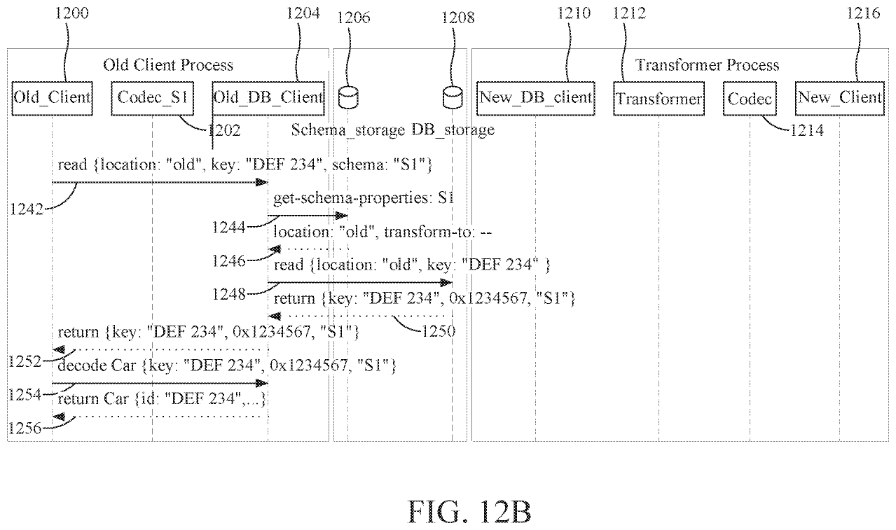

According to another embodiment, in some cases it may be desirable to transform encoded records back to an earlier schema, e.g., transform records from schema S2 to schema S1, while still allowing newer clients to store and use data using a newer schema. This process is known as “reverse migration” and will now be described with respect to FIGS. 12A and 12B, where schema S1 is the “old” schema and schema S2 is the “new” schema.

In FIGS. 12A and 12B, the various nodes and functions which perform operations and/or receive information include an old client 1200, a codec S1 1202, on old DB client 1204 which is only capable of decoding/encoding according to schema S1, a schema storage 1206, a DB storage 1208, a new DB client 1210 which is capable of decoding/encoding according to both schema S1 and schema S2, a transformer function 1212, a codec S1_and_S2 1214 and a new client 1216. Initially, the new client 1216 transmits an encode message 1218, e.g., to encode the record associated with Car to the codec S1_and_S2 1214. Codec S1_and_S2 1214 then returns the blob associated with Car to the new client 1216. The new client 1216 then sends the encoded record including the key, e.g., “DEF 234”, encoded blob and schema S2 to the new DB client 1210 for storage as shown in message 1222. The new DB client 1210 examines the schema properties in the schema storage 1206 for the S2 schema and determines that it should also store the S1 schema as well as being informed as to where the S2 encoded record should be stored. These steps are shown in messages 1224 and 1226.

The new DB client 1210, again in association with the schema storage 1206, examines the schema properties for schema S1, finding the location to store the S1 encoded record as shown in messages 1228 and 1230. The new DB client 1210 invokes the appropriate client-specific transformer, e.g., transformer function 1212, and transforms the S2 encoded record using the S1 schema as shown in messages 1232 and 1234. The new DB client 1210 then instructs the DB storage 1208 store the encoded S1 record and the S2 encoded record in both the “old” and “new” locations, respectively. This is shown in messages 1236 and 1238. The new DB client 1210 then informs the new client 1216 in message 1240 which is some type of general acknowledgement message describing completion and/or commitment to the process.

Continuing the reverse-migration example, the old client 1200 sends a message 1242 instructing the old DB client 1204 to read a record, using a particular key, e.g., “DEF 234”, and schema S1. The old DB client 1204 examines the schema properties of the S1 schema and determines the location of the S1 stored data by communicating with the schema storage 1206 as shown in messages 1244 and 1246. The old DB client 1204 retrieves the information stored in the “old” location including the S1 schema and for the specified key by communicating with the schema storage 1206 as shown in messages 1248 and 1250. The old DB client 1204 then transmits the retrieved record to the old client 1200 as shown in message 1252. The old client then transmits the record including the blob and specified key associated with the previously retrieved record to the codec 1202 as shown in message 1254. The codec 1252 then decodes the data using the S1 schema and transmits the decoded record back to the old client 1200 as shown in message 1256, where the old client 1200 does not know that the data originally was written by the new client 1216 using the S2 schema.

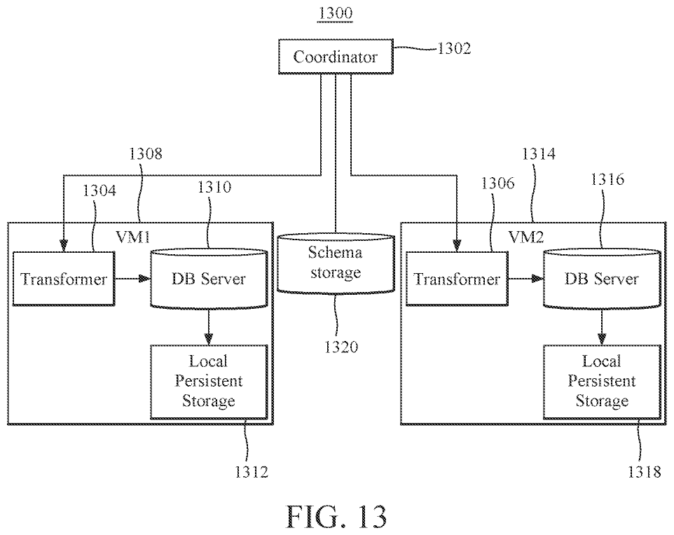

According to an embodiment, the various features and functions described in FIGS. 3-12 can also be performed using a cloud based, or partially cloud-based architecture 1300 as shown in FIG. 13. For example, there can be a coordinator node 1302, e.g., a client server 404 or 410, which coordinates different transformer functions 1304 and 1306 which can be based locally or in the cloud. The cloud architecture 1300 also includes a first virtual machine (VM1) 1308 which can include transformer function 1304, a DB server 1310 and a local persistent storage 1312. Additionally, the cloud architecture can include a second VM (VM2) 1314 which can include transformer function 1306, another DB server 1316 and another local persistent storage 1318. A schema storage 1320 is also shown which performs the function of schema storage(s) previously described herein.

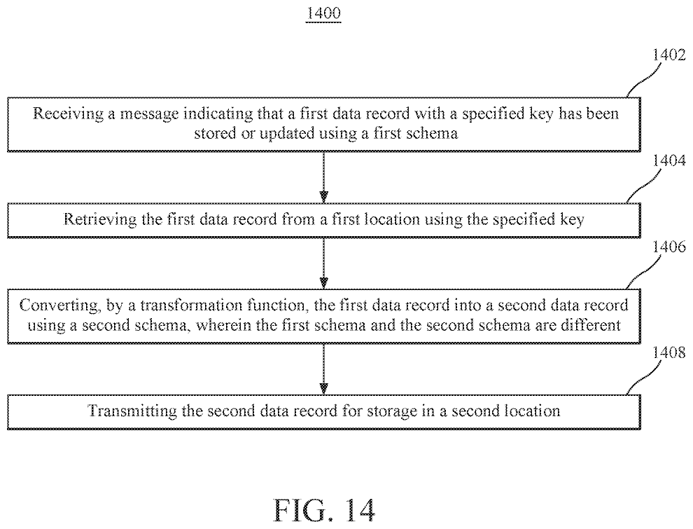

According to an embodiment, there is a method for multi-version upgrading of data records (or other forms of data) in a data processing system as shown in FIG. 14. The method 1400 includes: in step 1402, receiving a message indicating that a first data record with a specified key has been stored or updated using a first schema; in step 1404, retrieving the first data record from a first location using the specified key; in step 1406, converting, by a transformation function, the first data record into a second data record using a second schema, wherein the first schema and the second schema are different; and in step 1408, transmitting the second data record for storage in a second location.

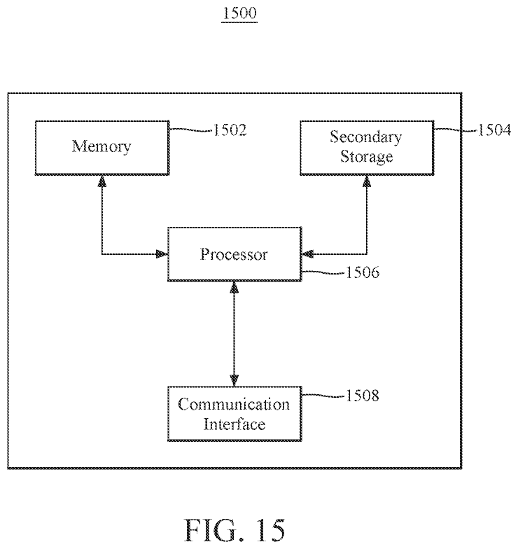

Embodiments described above can be implemented in devices or nodes, e.g., the client server, the DB server, a migration coordinator node and a database. An example of such a node which can perform the functions described in the various embodiments is shown in FIG. 15. The node 1500 includes a processor 1506, a memory 1502, a secondary storage 1504 and an interface 1508. The processor 1506 can execute applications as well as perform the functions of a codec and a transformer. The memory 1502 can include instructions for implementing features described associated with the applications, codecs, transformers, as well as for such functions as migration and reverse-migration. The memory 1502 and the secondary storage 1504 can also be used to perform the storage functions associated with the schema storage, other DBs and the persistent storage. The interface 1508 can be a communications interface used to communicate with operators, networks and the various nodes/functions described herein associated with the various embodiments.

As described above, embodiments describe multi-version upgrading of data records in a data processing system. According to an embodiment, an exemplary data processing system can be used as a portion of a Business Support System (BSS). The BSS can include a BSS Common Information Layer (CIL) server as well as one or more BSS clients. According to an embodiment, the BSS CIL server is an example of a DB server, e.g., DB server 416, and the BSS CIL server enables different types and different versions of BSS applications to share and access data records in the CIL. In this context, a BSS client is an example of a client server, e.g., first client 404 and/or second client 410.

According to an embodiment, BSS clients support operations in a telecommunication network which includes a radio access network (RAN) and a core network (CN). For example, the given BSS clients each process subscriber records, where a subscriber record can be considered as a defined type of record. However, in this example, not all of the BSS clients use or process the same fields within each subscriber record and, indeed, different types of BSS clients or different versions of the same type of BSS client may not use the same schema for structuring data records. Therefore, the various embodiments described above associated with multi-version upgrading of data records in a data processing system, e.g., storage of multiple versions of data records to simultaneously exist in different locations, migration and reverse migration, can be implemented in a BSS.

The disclosed embodiments provide methods and devices for multi-version upgrading of data in a data processing system. It should be understood that this description is not intended to limit the invention. On the contrary, the embodiments are intended to cover alternatives, modifications and equivalents, which are included in the spirit and scope of the invention. Further, in the detailed description of the embodiments, numerous specific details are set forth in order to provide a comprehensive understanding of the claimed invention. However, one skilled in the art would understand that various embodiments may be practiced without such specific details.

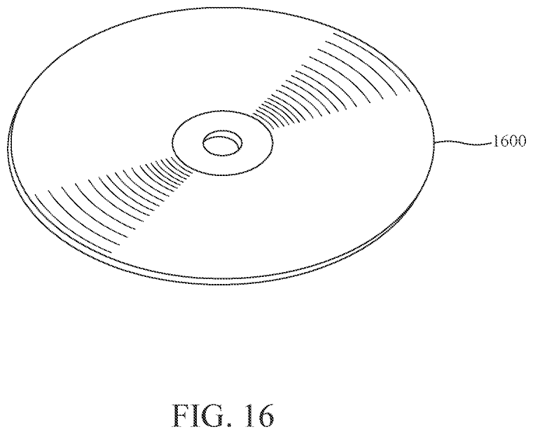

As also will be appreciated by one skilled in the art, the embodiments or portions of the embodiments may take the form of an entirely hardware embodiment or an embodiment combining hardware and software aspects. Further, portions of the embodiments may take the form of a computer program product stored on a computer-readable storage medium having computer-readable instructions embodied in the medium. Any suitable computer-readable medium may be utilized, including hard disks, CD-ROMs (an example of which is illustrated as CD-ROM 1600 in FIG. 16), digital versatile disc (DVD), optical storage devices, or magnetic storage devices such as floppy disk or magnetic tape. Other non-limiting examples of computer-readable media include flash-type memories or other known memories.

Although the features and elements of the present embodiments are described in the embodiments, in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

1. A method for multi-version updating of data records in a data processing system, the method comprising:
receiving a message indicating that a first data record with a specified key has been stored or updated using a first schema;
retrieving the first data record from a first location (loc_1) using the specified key;
converting, by a transformation function, the first data record into a second data record using a second schema, wherein the first schema are different; and
transmitting the second data record for storage in a second location (loc_2).

2. The method of claim 1, wherein the first and second schemas are different organizational patterns which are used for representing a data record stored in a database.

3. The method of claim 1, wherein the first schema includes a first location parameter which indicates that data records encoded using the first schema are to be stored in the first location (loc_1) and wherein the second schema includes a second location parameter which indicates that the data records encoded using the second schema are to be stored in the second location (loc_2).

4. The method of claim 1, wherein the first and second schemas include a notify parameter which indicates whether updating or storing a data record encoded by the respective schema triggers generation of the message.

5. The method of claim 1, wherein the first and second schemas each include a transform parameter which indicates the transformation function to be used to transform a data record encoded with the respective schema.

6. The method of claim 1, further comprising:
creating the second schema;
encoding a third data record with the first schema generating a first Binary Large OBject (blob);
encoding the third data record with the second schema generating a second blob; and
storing both the first blob and the second blob in a persistent memory storage.

7. The method of claim 1, further comprising:
transforming all data records encoded with the first schema into data records encoded with the second schema; and
storing all of the data records encoded with the second schema.

8. The method of claim 7, further comprising:
deleting all of the data records encoded with the first schema after transforming all of the data records encoded with the first schema into data records encoded with the second schema has been completed.

9. The method of claim 1, wherein the transformation function is an idempotent transformer operation.

10. A data processing system configured for multi-version updating of data records, the system comprising:
a first client device which receives a message indicating that a first data record with a specified key has been stored or updated using a first schema;
wherein the first client device retrieves the first data record from a first location (loc_1) using the specified key;
a transformation function processor, associated with the first client device, which converts the first data record into a second data record using a second schema, wherein the first schema and the second schema are different; and
wherein the first client device transmits the second data record for storage in a second location (loc_2).

11. The system of claim 10, wherein the first and second schemas are different organizational patterns which are used for representing a data record stored in a database.

12. The system of claim 10, wherein the first schema includes a first location parameter which indicates that data records encoded using the first schema are to be stored in the first location (loc_1) and wherein the second schema includes a second location parameter which indicates that the data records encoded using the second schema are to be stored in the second location (loc_2).

13. The system of claim 10, wherein the first and second schemas include a notify parameter which indicates whether updating or storing a data record encoded by the respective schema triggers generation of the message.

14. The system of claim 10, wherein the first and second schemas each include a transform parameter which indicates the transformation function to be used to transform a data record encoded with the respective schema.

15. The system of claim 10, further comprising:
wherein the first client device creates the second schema;
a codec associated with the first client device which encodes a third data record with the first schema to generate a first Binary Large OBject (blob);
wherein the codec of the first client device encodes the third data record with the second schema generating a second blob; and
a persistent memory storage which stores both the first blob and the second blob.

16. The system of claim 10, further comprising:
wherein the first client device transforms all data records encoded with the first schema into data records encoded with the second schema; and
a database server which stores all of the data records encoded with the second schema.

17. The system of claim 16, wherein the database server deletes all of the data records encoded with the first schema after transforming all of the data records encoded with the first schema into data records encoded with the second schema has been completed.

18. The system of claim 10, wherein the transformation function is an idempotent transformer operation.

19. A computer-readable storage medium containing a computer-readable code that when read by a computer causes the computer to perform a method of for multi-version updating of data records in a data processing system, the method comprising:
receiving a message indicating that a first data record with a specified key has been stored or updated using a first schema;
retrieving the first data record from a first location (loc_1) using the specified key;
converting, by a transformation function, the first data record into a second data record using a second schema, wherein the first schema are different; and
transmitting the second data record for storage in a second location (loc_2).

20-23. (canceled)
